(19) United States
(12) Patent Application Publication
(10) Pub. No.: US 2010/0177597 A1
(43) Pub. Date: Jul. 15, 2010

(54) AROMA ALARM CLOCK

(76) Inventor: Ming-Wei TSAI, Taipei Hsien (TW)

Correspondence Address: BIRCH STEWART KOLASCH & BIRCH, PO BOX 747, FALLS CHURCH, VA, 22040-0747, US

(21) Appl. No.: 12/354,111

(22) Filed: Jan. 15, 2009

(51) Int. Cl. G04B 47/00

(52) U.S. Cl. 368/10

(57) ABSTRACT

An aroma alarm clock includes an outer case in which are mounted a time setting module, an aroma module, and a power supply module. The outer case has a plurality of air inlets and a plurality of air outlets. The time setting module includes a plurality of button switches and a microcontroller chip. The aroma module has a fan and a fan cover. The fan is mounted to a first side of the fan cover and a container compartment is defined between the fan cover and the outer case for storing an aroma substance. The microcontroller chip is operated to control time display, alarm setting, aroma diffusion, time setting for releasing an aroma, and illumination. The air is drawn in the outer case, through the aroma substance in the container compartment and released out of the outer case at a preset time to wake up the user.

### BACKGROUND OF THE INVENTION

1. Field of the Invention

The present invention generally relates to an alarm clock, and more particularly to an aroma alarm clock whose functions including time display, alarm, aroma releasing and aroma releasing at a preset time.

2. The Prior Arts

A conventional alarm clock usually only provides simple functions, such as time display and alarm setting. Further, most of the alarm clocks use noisy buzzing sound to wake up the user, which makes the user to have a bad mood after wake up. Therefore, certain users use a cell phone as an alarm clock and program their preferred ring tone as alert sound. However, using the cell phone as an alarm clock may have certain disadvantages. For example, the user needs to set the alarm time every time before going to bed. In addition, the alarm of the cell phone may not work if the battery of the cell phone runs out of power.

Therefore, an alarm clock using smell to wake up a user is proposed. People wakened up by an aroma will have a much better and peaceful mood than wakened up by the noise.

### SUMMARY OF THE INVENTION

A primary objective of the present invention is to provide an aroma alarm clock that is capable of displaying time and releasing an aroma at a preset time as an alarm signal instead of conventional buzzing sounds.

Another objective of the present invention is to provide an aroma alarm clock that can continuously diffuse an aroma like an air freshener, which freshens a surrounding environment or helps people drift away to a deep and peaceful sleep.

Still another objective of the present invention is to provide an aroma alarm clock that is provided with various light patterns and is suitable for ornamental decoration.

In order to achieve the objectives, the aroma alarm clock according to an embodiment of the present invention comprises an outer case in which are mounted an aroma module, a power supply module, and a time setting module. A first side of the outer case is provided with a plurality of air inlets, and a second side of the outer case is provided with a plurality of air outlets.

The aroma module comprises a fan and a fan cover. The fan is mounted to a first side of the fan cover and a container compartment is defined between a second side of the fan cover and the outer case for receiving an aroma substance. The time setting module comprises a main circuit board and a button circuit board. The main circuit board is coupled with a microcontroller chip, a sound generator, and a plurality of light-emitting diodes. Buttons for setting and a display screen are exposed out of the outer case. The power supply module is electrically connected with the fan and the time setting module.

Through operation of the buttons, the microcontroller chip can be configured to drive the display screen to display time as a conventional clock, or set the alarm time as a conventional alarm clock. In addition, the fan may also be activated for continuously diffusing an aroma. Furthermore, the aroma alarm clock may also be set to release the aroma at a preset time.

Moreover, the microcontroller chip may also control illumination of the light-emitting diodes on the main circuit board. Vivid light effects produced by the light-emitting diodes can include flashing light, rotating or alternated color illuminating effects, which can be visible through the display screen, or a transparent outer case. Thus, the aroma alarm clock can be used as an ornament.

Compared to a conventional alarm clock only provided with time display and alarm function, the aroma alarm clock according to the present invention is provided with various functions including time display, alarm, air freshening, and aroma alarm function. In particular, the aroma alarm clock can release an aroma that can be selected for either facilitating sleeping or stimulating wakeup, which is more refreshing than conventional wakeup alarm sound. As the aroma alarm clock is able to diffuse the aroma, it is suitable for use as an air freshener at indoor. In addition, the microcontroller chip can control illumination of the light-emitting diodes to achieve various light effects such as flashing light, rotating or alternated color illuminating effects. The aroma alarm clock thus can also be used as an ornament.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing an aroma alarm clock according to an embodiment of the present invention;

FIG. 2 is a perspective view showing the aroma alarm clock of FIG. 1; and

FIG. 3 is a cross-sectional view taken along lines III-III in FIG. 2.

### DETAILED DESCRIPTION OF THE PREFERRED EMBODIMENTS

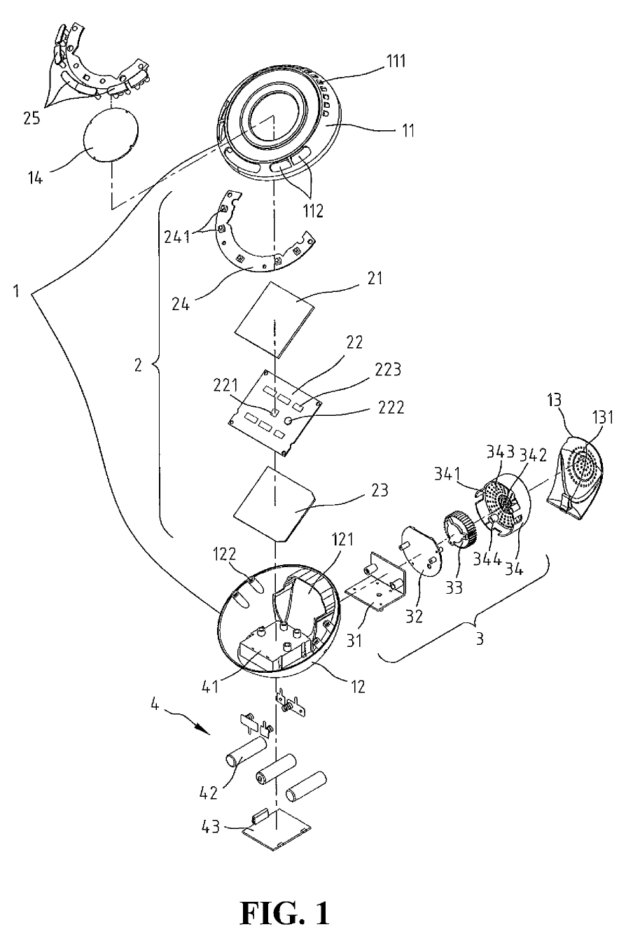

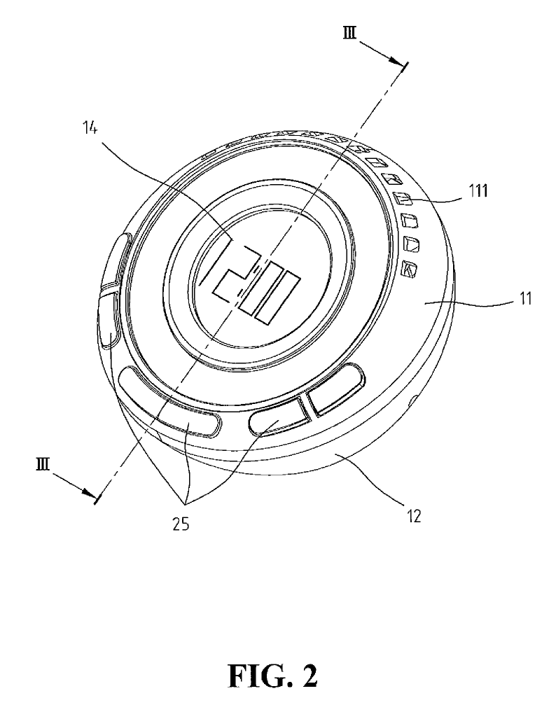

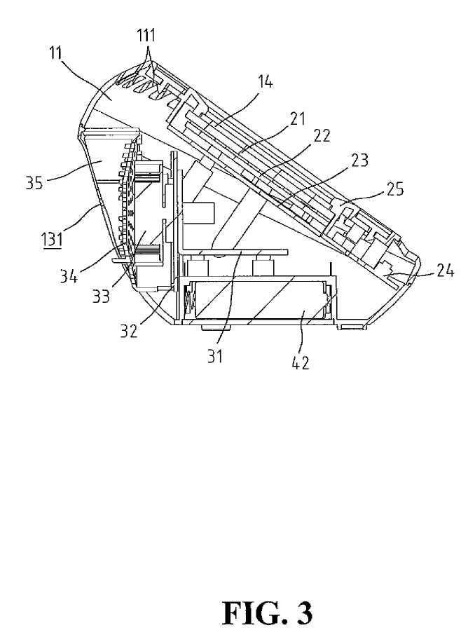

Referring to FIGS. 1-3, an aroma alarm clock according to an embodiment of the present invention includes an outer case 1, a time setting module 2, an aroma module 3, and a power supply module 4.

The outer case 1 includes an upper casing 11, a lower casing 12 and a removable rear panel 13 that assemble with one another to define an inner space for mounting the aforementioned modules. The upper casing 11 has an annular shape. A margin of the upper casing 11 is provided with a plurality of air outlets 111 and a plurality of button placement holes 112. A central hollow region of the upper casing 11 has a transparent plate 14. The lower casing 12 serves as support and a container, having an inclined upper edge corresponding to the upper casing 11. A bottom of the lower casing 12 includes a battery case 41 for placement of batteries 42. At a side of the battery case 41, the lower casing 12 includes a rear opening 121 for assembling with the rear panel 13. The upper edge of the lower casing 12 has a plurality of lugs 122 for assembling the upper casing 11 and lower casing 12 together. A plurality of air inlets 131 is arranged in concentric circles on the rear panel 13.

The time setting module 2 includes a display screen 21, a main circuit board 22, a backlight unit 23 and a button circuit board 24. The display screen 21 may be a LED screen, a vacuum fluorescent display (VFD) or a liquid crystal display (LCD). The button circuit board 24 having a plurality of button switches 241 is mounted at a bottom of the upper casing 11 at a position corresponding to the button placement holes 112, so that buttons 25 and the corresponding button switches 241 are connected and aligned within the button placement holes 112. The buttons 25 are used to set up different functions, such as time display, alarm time setting, releasing aroma, alarm types (including aroma wake up, buzzer wake up, and aroma-buzzer wake up), and light decoration. The main circuit board 22 includes a microcontroller chip 221, a sound generator 222 and a plurality of light-emitting diodes 223. The microcontroller chip 221 is adapted to control time display on the display screen 21, illumination from the light-emitting diodes 223, alarm sound from the sound generator 222, aroma releasing, and time setting.

The aroma module 3 includes a frame which has an L-shape main support frame 31 fixed on the battery case 41 and an auxiliary frame 32 connected with the main support frame 31. The auxiliary frame 32 has an approximately circular shape and has one side fixedly mounted with a fan 33 that is electrically connected with the main circuit board 22 and controlled by the microcontroller chip 221. The aroma module 3 is also provided with a cap-shaped fan cover 34 which includes a separator plate 341. The separator plate 341 is provided with venting channels 342 at a center thereof and a plurality of airflow apertures 343 disposed radially around the venting channels 342. The fan cover 34 includes a plurality of lugs 344 for assembling the fan cover 34 with the auxiliary frame 32, and the fan 33 is disposed therebetween. A container compartment 35 is defined between the rear panel 13 and the fan cover 34 for storage of an aroma substance. The position of the container compartment 35 corresponds to those of the air inlets 131 on the rear panel 13. The aroma substance placed in the container compartment 35 may include herbs, spices, perfumes, aromatic powders, essential oils, fragrance oils, activated carbon, water, or like substance suitable for refreshing ambient air. The rear panel 13 may be opened to replace or refill the aroma substance.

The power supply module 4 includes a plurality of batteries 42 placed in the battery case 41, and a battery lid 43 closing a bottom of the battery case 41. The power supply module 4 includes may also include an electric cord (not shown) to plug into a socket. The power supply module 4 is electrically connected with the main circuit board 22, the button circuit board 24 and the fan 33. An aroma alarm clock can thereby be provided according to the construction shown in FIGS. 1-3.

The operation of the aroma alarm clock is now described with reference to FIGS. 1-3. When the power is on, the clock time, the alarm time and the alarm type can be set up by the buttons 25. When it reaches the alarm time, the sound generator 222 provides an alert sound as a conventional alarm clock or a clock radio in a sound alarm type. In addition, the fan 33 can also be activated by one of the button 25. As the fan 33 works, air is drawn in through the air inlets 131 of the rear panel 13, flows through the container compartment 35 containing the aroma substance, passes through the venting channel 342 and the airflow apertures 343 of the fan cover 34, disperses in the interior of the aroma alarm clock, and eventually exits through the air outlets 111 on the upper casing 11. The chosen aroma can help the user either refresh to wakeup or calm down to sleep. Thus, the aroma alarm clock according to the present invention can work as an air freshener or an aromatherapy device. The fan 33 may work with the alarm function. Therefore, when the wake up time arrives, the aroma alarm clock releases the aroma. The user is wakened up by the refreshing aroma instead of sound. The user can have a fine, peaceful and energetic day. Moreover, the aroma alarm clock according to the present invention can use sound, smell or both of them to wake up the user. Furthermore, the button 25 can turns on the light-emitting diodes 223 to illuminate the display screen 21 and choose the light patterns. The light-emitting diodes 223 are provided with various vivid light effects by programming sequences of switching parts on and off, such as flashing, rotating, alternating color illumination, etc. The light effects provided by the aroma alarm clock is visible through the transparent plate 14 and the upper casing 11 if this latter is also made of a transparent material. The aroma alarm clock thus can be used as an ornamental object.

Although the present invention has been described with reference to the preferred embodiment thereof, it is apparent to those skilled in the art that a variety of modifications and changes may be made without departing from the scope of the present invention which is intended to be defined by the appended claims.

1. An aroma alarm clock comprising:
an outer case having a plurality of air outlets at a first side thereof and a plurality of air inlets at a second side thereof;
a time setting module mounted in the outer case and comprising a main circuit board, a button circuit board and a display screen, the main circuit board coupled with a microcontroller chip, a sound generator and a plurality of light-emitting diodes, the button circuit board coupled with a plurality of button switches, the display screen and the button switches exposed out of the outer case;
an aroma module disposed in the outer case and comprising a fan and a cap-shaped fan cover, the fan cover comprising a separator plate having a plurality of venting channels, the fan electrically connected with the microcontroller chip and mounted to a first side of the separator plate, a container compartment defined between a second side of the separator plate and the outer case for receiving an aroma substance; and
a power supply module disposed in the outer case and electrically connected with the time setting module and the fan, the power supply module including a power source.

2. The clock according to claim 1, wherein the outer case comprises an upper casing, a lower casing, and a removable rear panel, the air inlets are disposed on the rear panel, the container compartment is defined between the rear panel and the fan cover.

3. The clock according to claim 1, wherein a frame is mounted in the outer case and the fan and the fan cover are mounted on the frame.

4. The clock according to claim 2, wherein a frame is mounted in the outer case and the fan and the fan cover are mounted on the frame.

5. The clock according to claim 1, wherein the power source is one of a battery, an electric cord and both of the battery and the electric cord.
